(19) United States
(12) Patent Application Publication
(10) Pub. No.: US 2023/0150582 A1
(43) Pub. Date: May 18, 2023

(54) Outer Skin Component for a Motor Vehicle and Method for Producing an Outer Skin Component

(71) Applicant: Bayerische Motoren Werke Aktiengesellschaft, Muenchen (DE)

(72) Inventor: Thomas MIADOWITZ, Ergolding (DE)

(21) Appl. No.: 17/912,935

(22) PCT Filed: Jun. 2, 2021
(86) PCT No.: PCT/EP2021/064739

§ 371 Date: Sep. 20, 2022

(30) Foreign Application Priority Data
Jul. 21, 2020 (DE) 10 2020 119 196.0

(51) Int. Cl. B62D 29/04; B62D 25/10; B62D 25/12; B62D 25/02; B32B 5/26; B32B 27/12

(52) U.S. Cl. CPC B62D 29/043; B62D 25/105; B62D 25/12; B62D 25/02; B32B 5/266; B32B 27/12; B29C 70/48

(57) ABSTRACT

An outer skin component for a motor vehicle is designed as a shell component with an outer shell and an inner shell, which are in each case designed as fiber-reinforced plastics shells with a fiber reinforcement embedded into a thermosetting plastic matrix. The fiber reinforcement of the outer shell consists of one or more layers of nonwoven material.

### BACKGROUND AND SUMMARY

The invention relates to a fiber-reinforced outer skin component for a motor vehicle.

Fiber-reinforced components on motor vehicles are known. Usually in such cases a plurality of plies of directed reinforcing fibers are embedded in a plastics matrix. When such a component is heated as part of the painting operation, the different expansion coefficients (also known as the delta-alpha problem) frequently result in fibers showing at the surface. The fiber plies beneath become visible.

Fibers showing in this way fall short of the exacting requirements imposed on the surface quality of outer skin components. Particularly in the case of fiber-reinforced plastics components, this results in costly and inconvenient work operations before and after painting, to ensure a class A surface. Fiber-reinforced components have, to date, been painted in stand-alone painting processes outside of the process chain, and installed on the vehicle afterward.

Against this background, the object of the invention is to provide a fiber-reinforced plastics component which is improved in terms of paintability and surface quality. The intention, more particularly, is for the plastics component to be producible inexpensively as an outer skin component for a vehicle and for painting together with the vehicle body to be made possible.

The object is achieved by an outer skin component and by a method for producing such a component in accordance with the independent claims. Further advantageous embodiments are apparent from the dependent claims and the description hereinafter.

A fiber-reinforced outer skin component for a motor vehicle is specified that is configured as a shell component having an outer shell and an inner shell. The inner shell is joined directly or indirectly to the outer shell, preferably by adhesive bonding. Characteristically, the inner shell and the outer shell together model the essential geometry of the outer skin component. In the installed state, the outer shell is facing outward on the vehicle, and the inner shell is facing inward. The outer shell preferably forms the outer skin of the outer skin component.

In accordance with the invention, both the outer shell and the inner shell are each configured as fiber-reinforced plastics shells having a fiber reinforcement embedded in a thermoset plastics matrix, the fiber reinforcement of the outer shell consisting of one or more plies of nonwoven material. In other words, the use of directed fibers is deliberately shunned in the outer shell. Nonwoven materials exclusively are used as reinforcing fibers in the outer shell.

In a nonwoven, the fibers take the form of random fibers, in other words without direction and with adventitious fiber direction. The distribution of the fibers in the nonwoven is arbitrary, with the result, in macroscopic viewing, that matrix and fibers are distributed more homogeneously in the component than in a component with directed fibers. It has now emerged that an outer shell comprising a fiber reinforcement exclusively of nonwoven materials forms only slight unevennesses, which the human eye still perceives as being homogeneous. Any sink marks and/or showthroughs are permissible, owing to their uniform distribution when the surface of the outer shell is viewed in its entirety, and are not a criterion for rejection. It has surprisingly been found that an outer shell of this kind can also pass through conventional painting operations for a metal body, such as a cathodic electrocoat operation with temperatures of up to 190 degrees, for example, without any impermissible unevennesses or showthroughs occurring on the surface. This is all the more surprising given that the heating in the cathodic electrocoat oven is accompanied by (virtually) 100% curing of the thermoset matrix material.

The fiber reinforcement of the outer shell may be formed of a single ply or of two or more plies of nonwoven materials, present in layers one over another. In principle, the nonwoven material is not restricted to particular fibers; instead, all known reinforcing fibers can be used.

In one embodiment, the fiber reinforcement of the outer shell is formed of glass fibers—that is the individual nonwoven plies consist of glass fibers. In this way a particularly good surface quality can be achieved, since the coefficient of thermal expansion of the glass fibers is closer to that of the matrix material and therefore the delta-alpha problem is reduced.

In an alternative embodiment, the fiber reinforcement of the outer shell is formed of carbon fibers, meaning that the individual nonwoven plies consist of carbon fibers. As a result of this, it is possible to achieve particularly low weight and higher mechanical strength.

In a further embodiment, surface optimization with accompanying low weight is achieved in that the fiber reinforcement of the outer shell is formed of carbon fibers and glass fibers. In this case the individual nonwoven plies may comprise only carbon fibers or only glass fibers and may be present in layers one above another. It is also possible to use nonwoven plies in which both carbon fibers and glass fibers are arranged.

The requirements relating to the strength of the outer skin component can be realized by way of the inner shell. For this purpose it may be advantageous, in one embodiment, if the fiber reinforcement of the inner shell comprises one or more plies of directed reinforcing fibers, such as carbon fibers, glass fibers or aramid fibers, for example. These fibers may take the form, for example, of a laid scrim, woven fabric and/or braid. Since the outer shell conceals the inner shell from sight, the requirements in terms of the surface quality of the inner shell are much lower.

In one preferred embodiment, the inner shell comprises at least one local reinforcement which provides the inner shell with, for example, stiffening that is in keeping with load paths. These one or more reinforcements may be formed, for example, by additional fiber plies, which are arranged in a locally delimited manner in regions of the inner shell. For example, the reinforcements may be visible as striplike thickenings on the inner shell.

The matrix material of the outer shell and of the inner shell is a thermoset matrix material; the same matrix system need not necessarily be used for the inner shell and the outer shell.

The outer skin component is preferably a vehicle hatch, such as a front/engine hood, a tailgate or a door, or a side wall of a motor vehicle.

Additionally specified is a method for producing an outer skin component which is configured as a shell component having an outer shell and an inner shell, more particularly for producing the shell component described above. The outer shell and the inner shell are preferably produced independently of one another and joined to one another in a subsequent step. The method accordingly comprises the steps of:

producing an outer shell, by subjecting a thermoset plastics matrix having a fiber reinforcement composed of one or more plies of nonwoven material to compression in a compression mold and curing,

producing an inner shell as a fiber-reinforced plastics component having a fiber reinforcement embedded in a thermoset plastics matrix, and

durably joining the outer shell to the inner shell to form the shell component.

The outer shell may be produced preferably by the RTM process (resin transfer molding) or by liquid resin molding. In the RTM process, the fiber reinforcement is infiltrated with the matrix material only when in the closed compression mold. In the liquid resin process, the matrix material is applied to the fiber reinforcement before the compression mold is closed, and is subsequently compressed with this reinforcement. Both processes are cost-effective processes compatible with long series, enabling the production of large numbers of units at low cost. For the production of the outer shell, advantageously, it is possible to forgo the use of prepregs, whose production and processing is costly and inconvenient.

Further to the processes stated above, another option for producing the inner shell is that of hybrid pressing when, for example, there are local reinforcements to be provided which are applied in the form of prepregs, for example, to the rest of the fiber plies of the inner shell.

The outer shell and the inner shell are joined durably and inseparably to one another to form the shell component. This is accomplished preferably by adhesively bonding the shell components to one another.

By virtue of its specific construction, the outer skin component described above can be painted along with the rest of the vehicle body in the existing process chain and in particular can also be put through the cathodic electrocoating operation. There is no need for separate painting operations. As a result, there are considerable potentials for savings and the possibility for painting of the components in the vehicle color.

Features and details described in connection with the shell component are also valid in connection with the method of the invention, and vice versa in each case, and so mutual reference is always made or can always be made with regard to the disclosure concerning the individual aspects of the invention.

Further advantages, features and details of the invention are apparent from the description hereinafter, in which exemplary embodiments of the invention are described in detail with reference to the drawings. In this connection, the features referred to in the claims and the description may each individually or in any desired combination be essential to the invention. In so far as the terms “can” or “may” are used in this patent application, they refer both to the technical possibility and to the actual technical realization.

Exemplary embodiments are illustrated below by means of the appended drawings.

### BRIEF DESCRIPTION OF THE DRAWINGS

FIG. 1 shows an illustrative shell component in an exploded representation; and

FIG. 2 shows a sectional view of the shell component from FIG. 1.

### DETAILED DESCRIPTION OF THE DRAWINGS

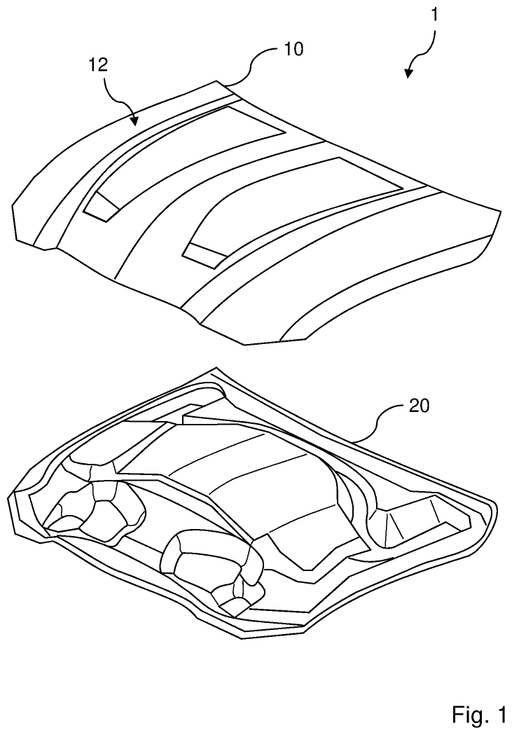

FIG. 1 shows an illustrative shell component 1 in the form of a front hatch of a motor vehicle. The shell component has an outer shell 10 and also an inner shell 20, which are joined to one another, preferably by adhesive bonding. The shell component 1 may comprise further elements, not represented, such as hinges or pockets, for example, which may be provided additionally or may be integrated, for example, in the inner shell 20. The outer shell 10 forms an outer face 12 of the shell component 1, which in the installed state on the vehicle faces outward. The inner shell 20 is arranged on the outer shell 10 side facing away from the outer face 12.

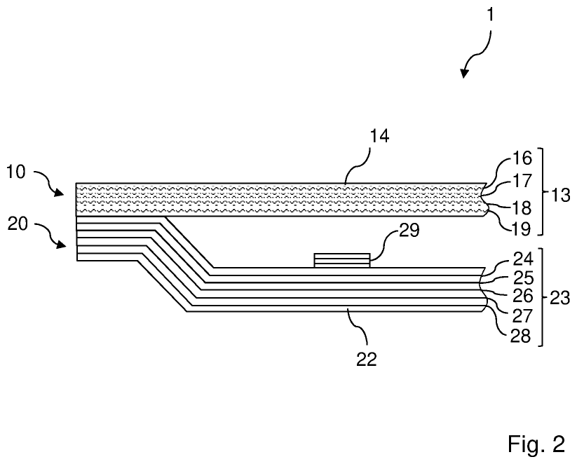

The outer shell 10 is configured as a fiber-reinforced plastics shell, and comprises a fiber reinforcement 13 composed of nonwoven materials, which is embedded in a thermoset plastic matrix 14. FIG. 2 shows a sectional view for illustrating the ply construction. Shown purely illustratively therein are four piles 16, 17, 18, 19 of a nonwoven material; the number may of course vary according to the requirements.

The inner shell 20 is likewise a fiber-reinforced plastics shell having reinforcing fibers embedded in a thermoset plastics matrix 22. The inner shell 20 comprises a fiber reinforcement 23 having a ply construction of multiple plies 24, 25, 26, 27, 28 (here, illustratively, 5 plies) of directed reinforcing fibers. The inner shell 20 additionally comprises at least one local reinforcement 29. For this purpose, in a locally confined region, additionally to the above-described construction, a prepreg strip having further reinforcing plies of directed continuous fibers and matrix material is also formed onto the inner shell 20.

For producing the shell component, the outer shell 10 and the inner shell 20 are first produced separately and then bonded adhesively to one another. The outer shell is produced preferably by the RTM process or by the liquid resin process; the inner shell may likewise be produced by these processes or in a hybrid molding process.

### LIST OF REFERENCE SIGNS

1 Shell component
10 Outer shell
12 Outer face
13 Fiber reinforcement
14 Plastics matrix
16, 17, 18, 19 Nonwoven plies
20 Inner shell
22 Plastics matrix
23 Fiber reinforcement
24, 25, 26, 27, 28 Plies of reinforcing fibers
29 Local reinforcement

1.-10. (canceled)

11. An outer skin component for a motor vehicle, comprising:
a shell component having an outer shell and an inner shell, which are each configured as fiber-reinforced plastics shells having a fiber reinforcement embedded in a thermoset plastics matrix, wherein
the fiber reinforcement of the outer shell is composed of one or more plies of nonwoven material.

12. The outer skin component according to claim 11, wherein
the fiber reinforcement of the outer shell is formed of glass fibers.

13. The outer skin component according to claim 11, wherein
the fiber reinforcement of the outer shell is formed of carbon fibers.

14. The outer skin component according to claim 11, wherein
the fiber reinforcement of the outer shell is formed of carbon fibers and glass fibers.

15. The outer skin component according to claim 11, wherein
the fiber reinforcement of the inner shell comprises one or more plies of directed reinforcing fibers.

16. The outer skin component according to claim 15, wherein
the inner shell further comprises least one local reinforcement.

17. The outer skin component according to claim 11, wherein
the outer skin component is a vehicle hatch or a side wall.

18. A method for producing an outer skin component which is configured as a shell component having an outer shell and an inner shell, the method comprising:
producing the outer shell, by subjecting a thermoset plastics matrix having a fiber reinforcement composed of one or more plies of nonwoven material to compression in a compression mold and curing;
producing the inner shell as a fiber-reinforced plastics component having a fiber reinforcement embedded in a thermoset plastics matrix; and
durably joining the outer shell to the inner shell to form the shell component.

19. The method according to claim 18, wherein
the outer shell is produced by an RTM process or by a liquid resin process.

20. The method according to claim 18, wherein
the outer shell and the inner shell are adhesively bonded to one another to form the shell component.
